(19) United States
(12) Patent Application Publication
(10) Pub. No.: US 2015/0194640 A1
(43) Pub. Date: Jul. 9, 2015

(54) SECONDARY CELL

(71) Applicant: Sharp Kabushiki Kaisha, Osaka (JP)

(72) Inventors: Yoshihiro Tsukuda, Osaka (JP); Takenori Onishi, Osaka (JP); Kazuo Yamada, Osaka (JP)

(21) Appl. No.: 14/408,525

(22) PCT Filed: Jun. 26, 2013
(86) PCT No.: PCT/JP2013/067441

§ 371 Date: Dec. 16, 2014

(30) Foreign Application Priority Data
Jun. 27, 2012 (JP) 2012-144714

(51) Int. Cl. H01M 2/02

(52) U.S. Cl. CPC H01M 2/024; H01M 2220/20

(57) ABSTRACT

A stacked body is pressed by a suitable pressing force in a stacking direction by a sufficient area.

In a cell case (20) of a secondary cell (1), a pair of two facing faces among four faces each forming one side of an opening are curved wall faces (201) and (201) in the shape of being curved toward an inner side of the cell case (20), and the two facing curved wall faces (201) and (201) press an electrode group (40) in a stacking direction of the electrode group (40).

### TECHNICAL FIELD

The present invention relates to a secondary cell in which cycle characteristics are improved.

### BACKGROUND ART

Recently, a lithium ion secondary cell has received attention as a storage cell for power storage. In particular, as a secondary cell which is used for power supply for driving a motor of an electric vehicle (EV), a hybrid electric vehicle (HEV), or the like, a large secondary cell having high energy has been desired. In addition, in order to reduce manufacturing cost of the cell, enlargement of the secondary cell is enhanced.

In general, the lithium ion secondary cell is formed by containing a stacked body which is formed of a positive electrode plate and a negative electrode plate facing each other with a separator interposed therebetween in a containing case, and by injecting a nonaqueous electrolytic solution. The positive electrode plate is formed of a cathodic active material layer, and the negative electrode plate is formed of an anodic active material layer.

In the lithium ion secondary cell of the configuration described above, since the active material layer is expanded and contracted at the time of charging and discharging, an active material might be separated or dropped off from the active material layer, and thus an internal short circuit might occur. In addition, the expansion and contraction of the active material layer might cause dissociation between the positive electrode plate and the negative electrode plate, and thus cycle characteristics might be degraded. Therefore, in order to prevent the expansion and contraction of the active material layer, various approaches of pressing the stacked body in the containing case have been made.

For example, in PTL 1, a cell pack is disclosed in which a power generation element that is obtained by staking a positive electrode plate, a separator, and a negative electrode plate and is wound in an oval spiral shape is pressed by a heat welding portion of a cell case of which a metal laminate resin film is sealed by heat welding.

In addition, in PTL 2, a lithium ion secondary cell including an outer can (a container) containing an electrode group, and a sealing plate that seals the outer can is disclosed, in which a convex portion formed on the sealing plate applies a pressing force to the electrode group.

### CITATION LIST

### Patent Literature

PTL 1: Japanese Unexamined Patent Application Publication No. 2000-100404 (published on Apr. 7, 2000)
PTL 2: Japanese Unexamined Patent Application Publication No. 2011-238504 (published on Nov. 24, 2011)

### SUMMARY OF INVENTION

### Technical Problem

However, in the configuration of the related art described above, the following problems occur.

In the technique disclosed in PTL 1, the heat welding portion of the cell case of which the metal laminate resin film is sealed by the heat welding presses the power generation element. Accordingly, a portion in which a pressing force is applied to the power generation element is mainly a portion on which the heat welding portion is positioned. The heat welding portion is arranged on a flat face of the cell to be parallel to a winding axis of the power generation element, but it is not conceivable that the heat welding portion is formed over the entire flat face, and thus it is not possible to press the power generation element over a sufficient area.

In addition, in the technique disclosed in PTL 2, the sealing body and the container apply a pressing force to the stacked body in a stacking direction. That is, a pressing force is applied to the stacked body in the stacking direction, as a surface, by interposing the stacked body between the sealing body and the container. Accordingly, the pressing force is applied by the sealing body and the container, and thus there is no symmetric property in a mechanism applying the pressing force, and it is difficult to control strength of the pressing force.

The present invention has been made in view of the problems described above, and is to realize a secondary cell which is able to press a stacked body with a suitable pressing force in a stacking direction by a sufficient area.

### Solution to Problem

In order to solve the problems described above, a secondary cell according to the present invention is a secondary cell in the shape of an approximately rectangular parallelepiped which contains an electrode group of a stacked structure formed of a positive electrode plate including a cathodic active material layer and a negative electrode plate including an anodic active material layer facing each other with a separator interposed therebetween. The secondary cell includes a cell case of which one face of the approximately rectangular parallelepiped is opened, and a cell lid that seals the opening, in which a pair of two facing faces among four faces each forming one side of the opening of the cell case are curved wall faces in the shape of being curved toward an inner side of the cell case, and the two facing curved wall faces press the electrode group in a stacking direction of the electrode group.

According to the configuration described above, the pair of two facing faces among the four faces each forming one side of the opening of the cell case are the curved wall faces in the shape of being curved toward the inner side of the cell case, and the two curved wall faces press the electrode group in the stacking direction of the electrode group. That is, the two facing curved wall faces press the electrode group contained in the cell case in the stacking direction.

Therefore, a surface of the electrode group which is perpendicular to the stacking direction thereof is pressed over a sufficient area. As a result, cycle characteristics of the secondary cell are improved. In addition, the pressing is performed by applying a pressing force by the two facing curved wall faces of the cell case, and thus there is a symmetric property in a mechanism applying the pressing force, and strength of the pressing force is easily controlled.

In addition, the curved wall faces of the cell case are in contact with the electrode group over the sufficient area, and thus it is possible to secure excellent heat dissipation. Accordingly, it is preferable that the cell case be formed of a material having high thermal efficiency. In addition, the cell case described above is in a shape having the curved wall faces curved toward the inner side, and thus it is possible to exhibit high physical resistance with respect to a pressure change in the cell case caused by charging and discharging.

Further, in the secondary cell of the present invention, the cell lid is fixed, between the two facing curved wall faces, in a state of pressing and widening curves of the curved wall faces.

Further, according to the configuration described above, the cell lid that seals the opening of the cell case is fixed, between the two facing curved wall faces of the cell case, in a state of pressing and widening the curves of the curved wall faces. Here, the curved wall faces of the cell case have curves, and when the curves are changed, it is possible to easily adjust an area pressing the electrode group and the strength of the pressing force.

Accordingly, the cell lid is attached such that the curves of the curved wall faces are pressed and widened, and thus it is possible to control the strength of the pressing force which is applied to the electrode group in the stacking direction. In addition, the cell lid is attached such that the curved wall faces are pressed and widened as described above, and thus when the opening of the cell case is sealed by the cell lid, it is possible to easily secure air-tightness of the secondary cell.

Further, in the secondary cell of the present invention, a distance between top portions of the curves of the two facing curved wall faces is in a range of 0.8 times to 1 time with respect to a length of a side of the cell case which is parallel to the stacking direction.

According to the configuration described above, further, the distance between the top portions of the curves of the two facing curved wall faces is in the range of 0.8 times to 1 time with respect to the length of the side of the cell case which is parallel to the stacking direction of the electrode group. That is, a height of the curve of each of the curved wall faces is 0.1 times or less with respect to the length of the side of the cell case which is parallel to the stacking direction of the electrode group.

Here, in order to press the surface of the electrode group which is perpendicular to the stacking direction over the sufficient area, it is advantageous that the height of the curve of the curved wall faces is high. However, when the height of the curve of the curved wall faces is high, a thickness of the electrode group which is able to be contained in the cell case becomes thin, and it is difficult to seal the opening of the cell case by the cell lid.

Therefore, according to the configuration described above, the surface of the electrode group which is perpendicular to the stacking direction is able to be pressed over the sufficient area, the thickness of the electrode group which is able to be contained in the cell case is increased as much as possible, and the opening of the cell case is able to be sealed by the cell lid.

Further, in the secondary cell of the present invention, the cell lid is provided with a positive electrode terminal electrically connected to the positive electrode plate of the electrode group, and a negative electrode terminal electrically connected to the negative electrode plate of the electrode group.

According to the configuration described above, further, the positive electrode terminal electrically connected to the positive electrode plate of the electrode group, and the negative electrode terminal electrically connected to the negative electrode plate of the electrode group are disposed on the cell lid.

The cell lid is not in contact with the electrode group, unlike the curved wall faces, and thus the positive electrode terminal and the negative electrode terminal are easily disposed. In addition, when the positive electrode terminal and the negative electrode terminal are disposed on the cell lid, positive electrode wires connecting the positive electrode plate of the electrode group and the positive electrode terminal of the cell lid, and negative electrode wires connecting the negative electrode plate of the electrode group and the negative electrode terminal of the cell lid are easily disposed.

### Advantageous Effects of Invention

As described above, the secondary cell of the present invention includes the cell case of which one face of the approximately rectangular parallelepiped is opened and the cell lid that seals the opening, in which the pair of two facing faces among the four faces each forming one side of the opening of the cell case are the curved wall faces in the shape of being curved toward the inner side of the cell case, and the two facing curved wall faces press the electrode group in the stacking direction of the electrode group.

Accordingly, the surface of the electrode group which is perpendicular to the stacking direction is pressed over the sufficient area, and thus the cycle characteristics of the secondary cell are improved. In addition, the pressing is performed by applying the pressing force by the two facing curved wall faces of the cell case, and thus there is a symmetric property in the mechanism applying the pressing force, and the strength of the pressing force is easily controlled.

In addition, the curved wall face of the cell case is in contact with the electrode group over the sufficient area, and thus it is possible to secure excellent heat dissipation. In addition, the cell case is in the shape having the curved wall face curved toward the inner side, and thus it is possible to exhibit high physical resistance with respect to the pressure change in the cell case caused by the charging and discharging.

### BRIEF DESCRIPTION OF DRAWINGS

FIG. 1 is an exploded perspective view illustrating a structure of a secondary cell according to an embodiment of the present invention.

FIG. 2 is a cross-sectional view illustrating the structure of the secondary cell illustrated in FIG. 1 cut along a stacking direction of an electrode group.

FIG. 3 is a cross-sectional view illustrating the structure of the secondary cell illustrated in FIG. 1 cut along an electrode surface of the electrode group.

FIG. 4 is an enlarged cross-sectional view illustrating an example of shapes of an opening of a cell case and a cell lid of the secondary cell illustrated in FIG. 1 before being welded.

FIG. 5 is an explanatory view illustrating a trajectory of a head for laser welding at the time of joining the cell lid and the cell case illustrated in FIG. 4 and other figures.

FIG. 6 is an enlarged cross-sectional view illustrating another example of the shapes of the opening of the cell case and the cell lid of the secondary cell illustrated in FIG. 1 before being welded.

FIG. 7 is an enlarged cross-sectional view illustrating still another example of the shapes of the opening of the cell case and the cell lid of the secondary cell illustrated in FIG. 1 before being welded.

FIG. 8 is an enlarged cross-sectional view illustrating yet another example of the shapes of the opening of the cell case and the cell lid of the secondary cell illustrated in FIG. 1 before being welded.

### DESCRIPTION OF EMBODIMENTS

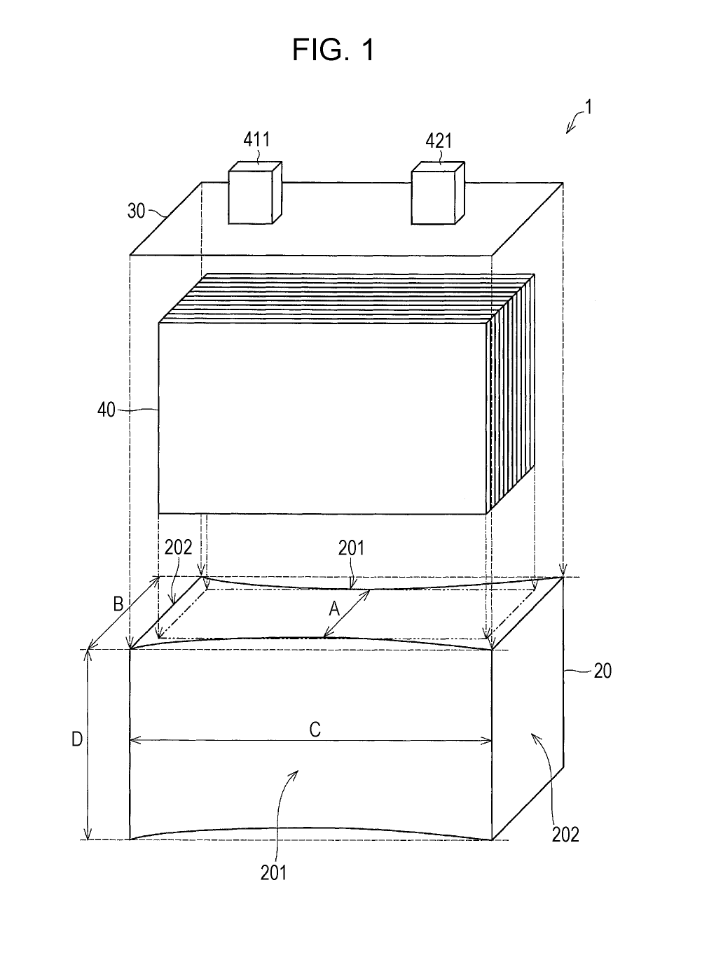

Embodiments of the present invention will be described in detail referring to FIG. 1 to FIG. 8. Furthermore, for convenience of description, in FIG. 1 to FIG. 8, the shape or the like of a secondary cell 1 is illustrated in an exaggerated manner.

[Outline of Secondary Cell]

FIG. 1 is an exploded perspective view illustrating a structure of the secondary cell 1 according to an embodiment of the present invention.

As illustrated in FIG. 1, an external shape of the secondary cell 1 which is a lithium ion secondary cell is in an approximately rectangular parallelepiped shape. The secondary cell 1 includes an electrode group 40 having a stacked structure, a cell case 20 containing the electrode group 40, and a cell lid 30 that seals an opening disposed in the cell case 20.

The cell case 20 is in the approximately rectangular parallelepiped shape of which one face is opened. That is, the cell case 20 includes four wall faces (curved wall faces 201 and 201, wall faces 202 and 202) which are erected from a placement surface as a bottom surface on which the electrode group 40 is mounted, and has the opening perpendicular to a stacking direction of the electrode group 40. The electrode group 40 is inserted into the cell case 20 from the opening, and a nonaqueous electrolytic solution is injected into the cell case 20, and then the opening is sealed by the cell lid 30.

In detail, a set of facing curved wall faces 201 and 201 among the four wall faces of the cell case 20 are in the shape of being curved toward an inner side of the cell case 20, and press the electrode group 40 in the stacking direction of the electrode group 40. The other two facing wall faces 202 and 202 are parallel to the stacking direction of the electrode group 40.

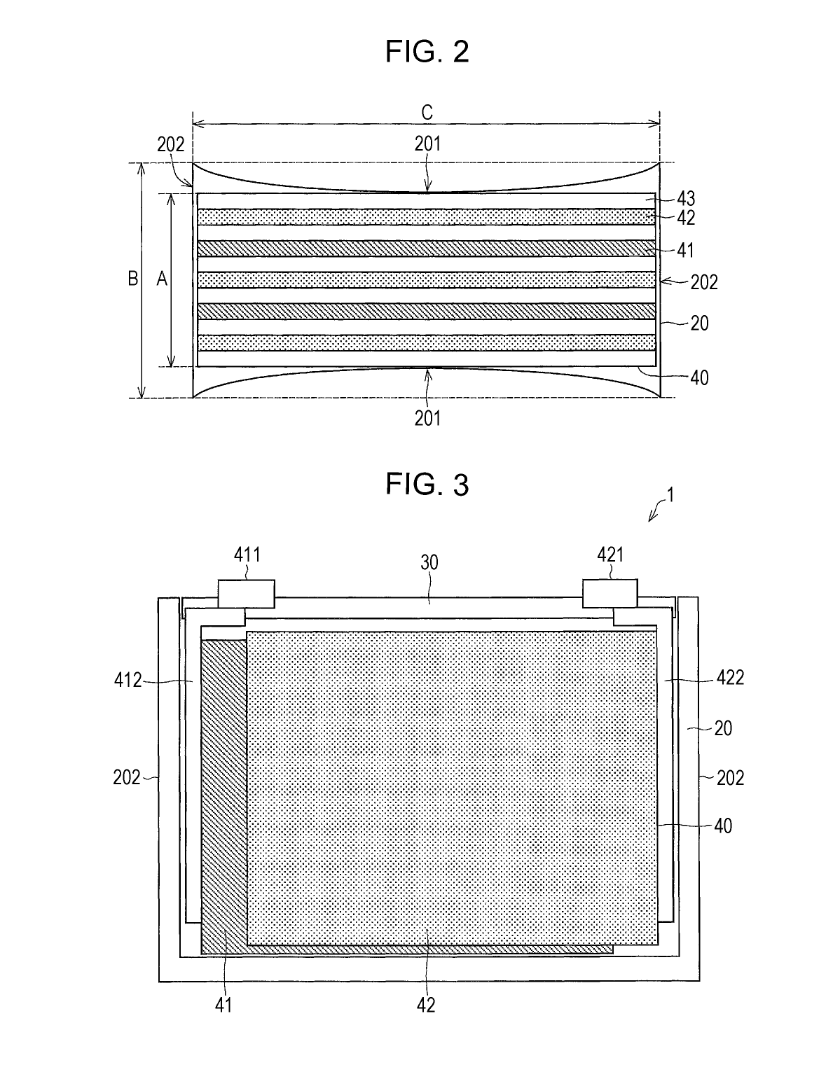

The cell lid 30 is in an approximately rectangular shape approximately similar to the shape of the placement surface (the bottom surface) of the cell case 20. The cell lid 30 includes a positive electrode terminal 411 and a negative electrode terminal 421. The positive electrode terminal 411 is electrically connected to a positive electrode plate 41 of the electrode group 40 (FIG. 2), and the negative electrode terminal 421 is electrically connected to a negative electrode plate 42 of the electrode group 40 (FIG. 2).

FIG. 2 is a cross-sectional view illustrating the structure of the secondary cell 1 cut along the stacking direction of the electrode group 40.

As illustrated in FIG. 2, the electrode group 40 is a power generation element of a stacked structure in which a separator 43 is interposed between the positive electrode plate 41 including a cathodic active material layer and the negative electrode plate 42 including an anodic active material layer.

As described above, in the secondary cell 1, the pair of two facing faces among the four faces each forming one side of the opening of the cell case 20 are the curved wall faces 201 and 201 in the shape of being curved toward the inner side of the cell case 20, and the two facing curved wall faces 201 and 201 press the electrode group 40 in the stacking direction of the electrode group 40. Here, the cell lid 30 is fixed, between the two facing curved wall faces 201 and 201, in a state of pressing and widening curves of the curved wall faces 201 and 201. Further, it is preferable that a distance between top portions of the curves of the two facing curved wall faces 201 and 201 be in a range of 0.8 times to 1 time with respect to a length of a side parallel to the stacking direction of the electrode group 40 of the cell case 20. In addition, it is preferable that the positive electrode terminal 411 electrically connected to the positive electrode plate 41 of the electrode group 40, and the negative electrode terminal 421 electrically connected to the negative electrode plate 42 of the electrode group 40 be disposed on the cell lid 30.

According to the structure described above, the electrode group 40 contained in the cell case 20 is pressed by the curved wall faces 201 and 201 in the stacking direction. Thus, a surface of the electrode group 40 which is perpendicular to the stacking direction is pressed over a sufficient area, and it is possible to improve cycle characteristics of the secondary cell 1. In addition, a pressing force is applied by the two facing curved wall faces 201 and 201 of the cell case 20, and thus there is a symmetric property in a mechanism applying the pressing force, and strength of the pressing force is easily controlled.

In addition, the cell case 20 has the following characteristics.

(1) The cell case 20 is formed of a material having high thermal efficiency. Accordingly, the curved wall faces 201 are in contact with the electrode group 40 over the sufficient area, and thus it is possible to secure excellent heat dissipation.

In addition, (2) the cell case 20 is in a shape having the curved wall faces 201 curved toward the inner side. Accordingly, it is possible to exhibit high physical resistance with respect to a pressure change in the cell case 20 caused by charging and discharging.

In addition, (3) the shape of the curves of the curved wall faces 201 of the cell case 20 is changed, and thus it is possible to easily adjust an area pressing the electrode group 40 and the strength of the pressing force. Here, the cell lid 30 is attached such that the curved wall faces 201 are pressed and widened, and thus it is possible to control the strength of the pressing force in the stacking direction which is applied to the electrode group 40 by the cell case 20 by changing the shape and attaching method of the cell lid 30. In addition, the cell lid 30 is attached such that the curved wall faces 201 are pressed and widened, and thus when the cell lid 30 is welded to the opening of the cell case 20, it is possible to easily secure air-tightness of the secondary cell 1.

FIG. 3 is a cross-sectional view illustrating the structure of the secondary cell 1 cut along an electrode surface of the electrode group 40.

As illustrated in FIG. 3, in the electrode group 40, the positive electrode plate 41 is electrically connected to the positive electrode terminal 411 of the cell lid 30 through a positive electrode wire 412, and the negative electrode plate 42 is electrically connected to the negative electrode terminal 421 of the cell lid 30 through a negative electrode wire 422. The positive electrode wire 412 is led from the positive electrode plate 41 to a wall face 202, and is disposed to the positive electrode terminal 411 through a space between the electrode group 40 and the wall face 202 and a space between the electrode group 40 and the cell lid 30. The same applies to the negative electrode wire 422.

(Shape of Secondary Cell)

First, a specific example of a shape of the secondary cell 1 is as follows. In FIG. 1 and FIG. 2, the cell case 20 and the cell lid 30 are formed of an aluminum plate having a thickness of 1 mm.

Further, a distance A connecting vertexes of the two curved wall faces 201 and 201 of the cell case 20 is 3.8 cm, and a distance B of the wall face 202 in the stacking direction is 4 cm. Therefore, the distance A connecting vertexes of the two curved wall faces 201 and 201 of the cell case 20 is 3.8/4=0.95 times with respect to the distance B of the wall face 202 in the stacking direction.

In addition, a distance C between the two wall faces 202 and 202 is 35 cm. Further, a depth D in a direction of inserting the electrode group 40 into the cell case 20 is 18 cm. Therefore, a solid content of the cell case 20 is a value between 35×3.8×18=2394 cm³ to 35×4×18=2520 cm³.

In addition, the cell lid 30 is in a rectangular shape in which a length of a long side is 35 cm and a length of a short side is 4 cm.

Further, a length of a long side of the surface of the electrode group 40 which is perpendicular to the stacking direction is 30 cm, and a length of a short side is 15 cm. Accordingly, an area of the surface of the electrode group 40 which is perpendicular to the stacking direction is 450 cm².

In addition, a thickness of the electrode group 40 in the stacking direction is 3.8 cm. Therefore, the electrode group 40 is in a thin plate shape having the stacking direction as a plate thickness direction.

(Shape of Curved Wall Face of Cell Case)

Here, a shape of the curved wall face 201 of the cell case 20 will be described in detail.

In the secondary cell 1, in order to press, in the stacking direction, the electrode group 40 contained inside, the distance A between the top portions of respective curves of the two facing curved wall faces 201 and 201 is in a range of 0.6 times to 1 time with respect to a length B of a side of the cell case 20 which is parallel to the stacking direction, and it is preferable that the distance A be in a range of 0.8 times to 1 time. This is based on the following results of experiments.

When the distance A is greater than 1 time with respect to the length B, the cell case 20 is not in contact with the electrode group 40 contained inside, and thus it is not possible to press the electrode group 40 in the stacking direction. In contrast, when the distance A is less than 0.6 times with respect to the length B, the opening of the cell case 20 is excessively deformed, and thus it is not possible to seal the opening of the cell case 20 by using the rectangular cell lid 30. Then, when the distance A is in the range of 0.6 times to 1 time with respect to the length B, it is possible to press the electrode group 40 contained inside of the cell case 20 in the stacking direction. However, as the distance A decreases with respect to the length B, the thickness of the electrode group 40 becomes thinner. That is, as a volume of the electrode group 40 decreases, energy density becomes lower, and thus it is not preferable.

(Shape of Electrode Group)

It is preferable that the electrode group 40 contained in the cell case 20 be in a thin flat plate shape in the stacking direction such that the pressing force is easily applied in the stacking direction. On the other hand, it is preferable that the electrode group 40 has a thickness of a predetermined value or greater in the stacking direction from a viewpoint of the energy density. In addition, the electrode group 40 is pressed by the curved wall faces 201 and 201 in the stacking direction, and the thickness of the electrode group 40 in the stacking direction is set to be slightly thicker than the distance A between the top portions of the respective curves of the curved wall faces 201 and 201.

In addition, it is preferable that the secondary cell 1 have a large cell capacity, for example, a cell capacity of 100 Ah or more. Accordingly, it is preferable that the area of the electrode surface of the electrode group 40 be 450 cm² or more. In addition, it is preferable that the length of the long side of the electrode surface of the electrode group 40 be 1.5 times or more with respect to the length of the short side. Furthermore, materials of the electrode group 40 and the electrolytic solution will be described later.

When the electrode group 40 has the size described above, it is preferable that the cell case 20 contain the electrode group 40 of which the area of the electrode surface is 450 cm² or more, and the solid content of the cell case 20 be 2000 cm³ or more and thus it is preferable that the length B of the side of the cell case 20 which is parallel to the stacking direction of the electrode group 40 be 4 cm or more.

(Shapes of Opening of Cell Case and Cell Lid)

Next, a connection for sealing the opening of the cell case 20 by the cell lid 30 will be described in detail.

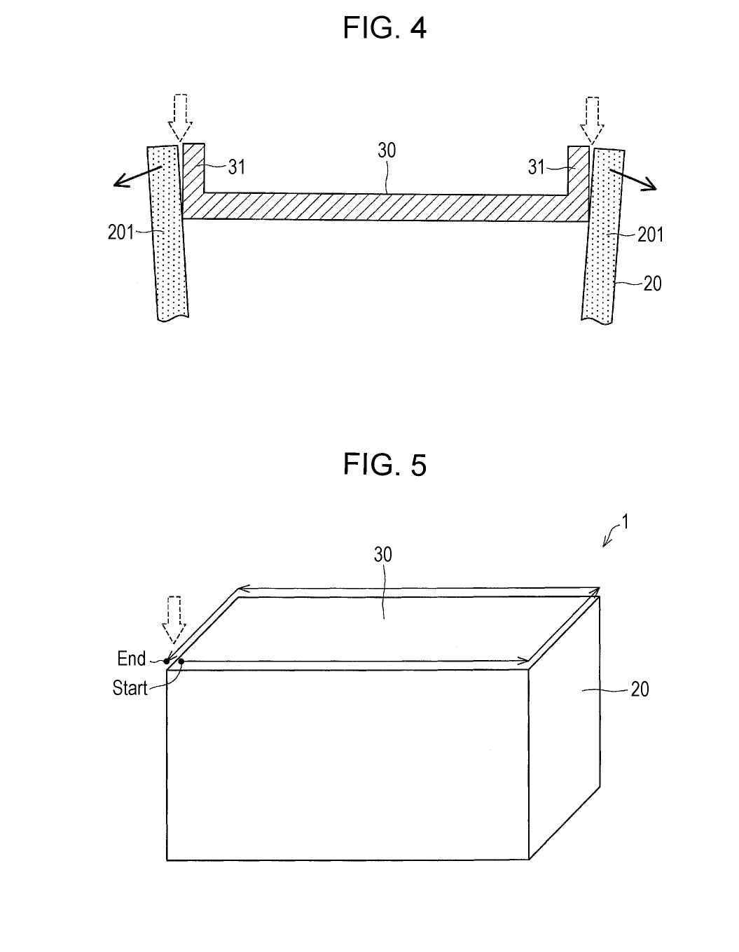

FIG. 4 is an enlarged cross-sectional view illustrating an example of shapes of the opening of the cell case 20 and the cell lid 30 before being welded.

As described above, in the opening of the cell case 20, the curved wall faces 201 are curved, and thus the distance A connecting the vertexes of the curved wall faces 201 in the stacking direction is shorter than the distance B of the wall face 202 in the stacking direction. On the other hand, each side of the cell lid 30 is not curved as described above, and is in an approximately rectangular shape. Accordingly, the cell lid 30 is inserted into the opening of the cell case 20, and as illustrated by a solid line arrow in FIG. 4, the curves of the curved wall faces 201 are pressed and widened toward an outer side of the cell case 20, and thus the cell lid 30 is attached. Here, in an example of FIG. 4, the cell lid 30 has, in four sides of end portions, extension portions 31 which are bent and extend along the curved wall faces 201 and the wall faces 202. These are formed to make sealing by laser welding reliable.

In general, when the laser welding is performed, a boundary face between materials to be welded is irradiated with a laser for welding. Therefore, as illustrated in FIG. 4, when a joint portion between the cell lid 30 and the cell case 20 is exposed in an upper portion of the cell lid 30, the joint portion is irradiated with the laser for welding from a direction of a dashed line arrow and is welded.

Here, FIG. 5 is an explanatory view illustrating a trajectory of a head for laser welding when the joint portion between the cell lid 30 and the cell case 20 is exposed in the upper portion of the cell lid 30.

As illustrated in FIG. 5, the head for laser welding is moved from a Start point to an End point while performing welding. As illustrated in an example of FIG. 5, when the cell lid 30 is in an approximately rectangular shape, the head for laser welding is also moved along an approximately rectangular trajectory, and thus the movement of the head for laser welding is easily controlled.

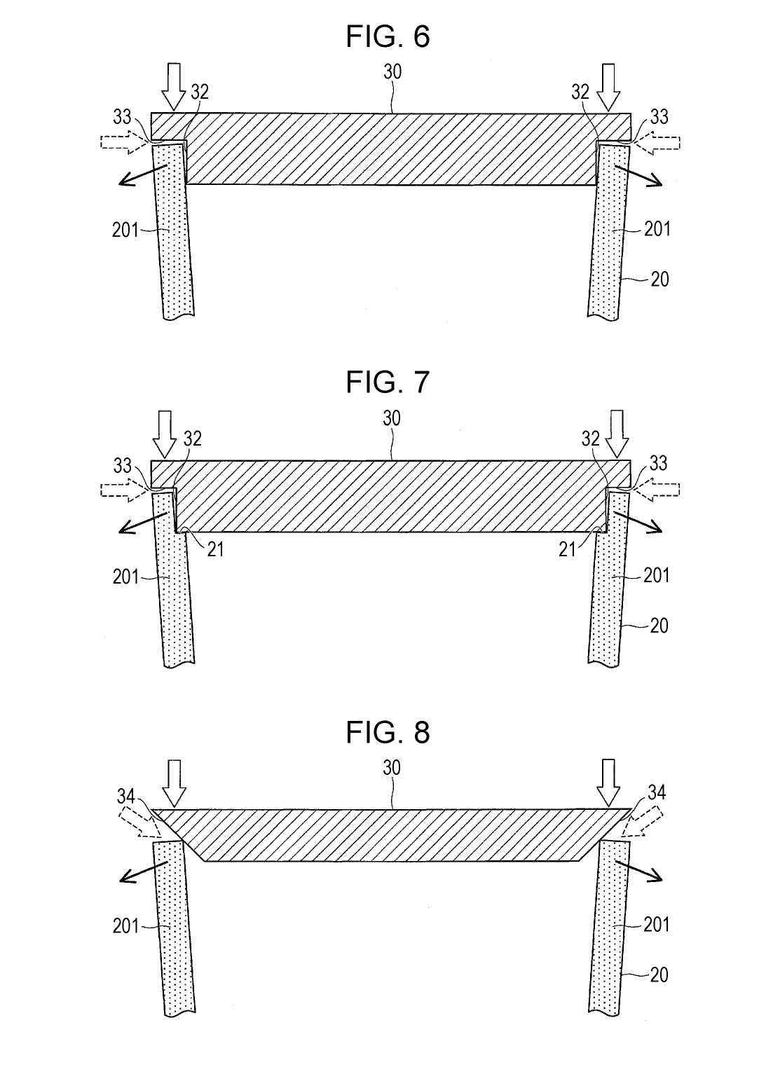

Further, an example of shapes of the opening of the cell case 20 and a connection portion of the cell lid 30 will be described. FIGS. 6 to 8 are enlarged cross-sectional views illustrating another example of the shapes of the opening of the cell case 20 and the cell lid 30 before being welded, respectively.

In an example illustrated in FIG. 6, the end portion of the cell lid 30 is in a stepped shape, and has a fitting portion 32 which is fitted between the curved wall faces 201 and 201, and an abutting portion 33 which abuts on an upper end of the curved wall face 201. In such a shape, the fitting portion 32 is inserted into the opening of the cell case 20, and thus the curves of the curved wall faces 201 are pressed and widened toward the outer side of the cell case 20 as illustrated by a solid line arrow in FIG. 6. Then, a position in which the abutting portion 33 abuts on the upper end of the curved wall face 201 is irradiated with the laser for welding from a direction of a dashed line arrow, and is welded.

Here, when a thickness of the abutting portion 33 is adjusted, the laser is emitted as illustrated by the solid line arrow of FIG. 6, and thus the laser is able to perform the welding while passing through the abutting portion 33. Thus, the head for laser welding is able to be moved along the upper portion not along a side portion of the cell case 20, and thus the movement of the head for laser welding is easily controlled, and a working space is reduced.

In addition, as illustrated in an example of FIG. 7, a reception portion 21 which receives the inserted fitting portion 32 may be formed on an inner side of the upper end of the curved wall faces 201 and the wall faces 202. It is preferable that the reception portion 21 be formed to abut on the fitting portion 32 when the abutting portion 33 abuts on the upper end of the curved wall face 201. Thus, it is possible to make the sealing by the laser welding more reliable.

In an example illustrated in FIG. 8, an inclined portion 34 which is cut at a slope is formed in the end portion of the cell lid 30. In such a shape, as the inclined portion 34 is positioned on the outer side of the cell case 20, a distance between the facing inclined portions 34 and 34 becomes wider. Accordingly, when the cell lid 30 is inserted into the opening of the cell case 20, the curves of the curved wall faces 201 are pressed and widened toward the outer side of the cell case 20 as illustrated by a solid line arrow of FIG. 8. Then, a position on which the inclined portion 34 abuts on the upper end of the curved wall face 201 is irradiated with the laser for welding from a direction of a dashed line arrow, and is welded.

In addition, similarly to FIG. 6, when a thickness of the inclined portion 34 is adjusted, the laser is emitted as illustrated by the solid line arrow of FIG. 7, and thus the laser is able to perform the welding while passing through the inclined portion 34.

As described above, various shapes for sealing the opening of the cell case 20 by the cell lid 30 are possible. Even in any shape, the secondary cell 1 is hermetically closed, and the pressing force is able to be applied to the electrode group 40 in the stacking direction. However, each shape is characterized by a distance in which the curves of the curved wall faces 201 are pressed and widened toward the outer side of the cell case 20 (that is, a range in which the pressing force is able to be adjusted) or an irradiating operation of the laser for welding, and is able to be selected according to a use. However, the shape for sealing the opening of the cell case 20 by the cell lid 30 is not limited to the examples described above.

(Material of Secondary Cell)

Next, a material of the secondary cell 1 will be described.

The cell case 20 and the cell lid 30 of the secondary cell 1 are formed of aluminum. However, the material is not limited thereto, and as the material of the cell case 20 and the cell lid 30, for example, a metal material including iron, nickel, Steel Use Stainless (SUS, stainless steel), or an alloy thereof which is generally used in a cell can is able to be used. In addition, a Ni plated copper plate or the like in which the metal material is subjected to plating may be used.

Here, it is preferable that the cell case 20, in particular, the curved wall faces 201, be formed of a material having high thermal efficiency. The curved wall faces 201 of the cell case 20 are in contact with the surface of the electrode group 40 which is perpendicular to the stacking direction over the sufficient area. Accordingly, the curved wall faces 201 are formed of a metal material having high thermal efficiency, and thus the secondary cell 1 is able to have excellent heat dissipation.

In addition, in the secondary cell 1, a portion other than the positive electrode terminal 411 and the negative electrode terminal 421 is covered with a heat shrinkable film which is formed of polyethylene as a material, and is subjected to an insulation process. As the heat shrinkable film, for example, a material including polyethylene (PE), polyethylene terephthalate (PET), polypropylene (PP), polystyrene (PS), and polyolefin (PO) is able to be preferably used.

Furthermore, in this embodiment, the cell case 20 and the cell lid 30 are formed of the aluminum plate having the thickness of 1 mm, but the material is not limited thereto. A plate for forming the cell case 20 may be a plate having a thickness which is greater than or equal to the thickness of the plate for forming the cell lid 30. The electrode group 40 contained in the cell case 20 is pressed in the stacking direction only by the cell case 20, and thus the cell case 20 is desired to have physical strength greater than or equal to that of the cell lid 30.

(Materials of Electrode Group and Electrolytic Solution)

Next, materials of the electrode group 40 and the electrolytic solution will be described.

The positive electrode plate 41 is formed of 90 wt % of LiFePO₄ as a cathodic active material, 5 wt % of acetylene black as a conductive material, 3 wt % of styrene-butadiene rubber as a binder, and 2 wt % of carboxy methyl cellulose (CMC) as a thickener.

The negative electrode plate 42 is formed of 98 wt % of a natural graphite negative electrode as an anodic active material, 1 wt % of styrene-butadiene rubber as a binder, 1 wt % of carboxy methyl cellulose as a thickener, and Cu having a thickness of 16 μm as a collector.

The separator 43 is a polyethylene plate having a thickness of 20 μm.

As the electrolytic solution, a solution in which a 1 mol concentration of LiPF₆ is dissolved in an organic solvent in which a ratio between Ethylene Carbonate (EC) and Diethyl Carbonate (DEC) is 3 to 7 is able to be used.

However, the materials of the electrode group and the electrolytic solution of the secondary cell are not limited to the materials described above, and a typical material used for the secondary cell is able to be used.

For example, when the secondary cell is a lithium ion secondary cell, as the positive electrode plate 41, a positive electrode plate including an oxide powder including lithium such as LiCoO₂, LiNiO₂, and LiMnO₂, conductive graphite such as Carbon Black as a main component, and a binding material such as PVdF is able to be used.

As the electrolytic solution, a solution in which LiPF₆ is dissolved in an organic solvent such as EC, Propylene Carbonate (PC), DEC, and Dimethyl Carbonate (DMC) is able to be used.

Similarly, as the negative electrode plate 42 and the separator 43, a negative electrode plate and a separator which are used for a typical secondary cell are able to be used.

(Others)

In this embodiment, a case where the pressing force by the curved wall faces 201 and 201 is adjusted by pressing and widening the shape of the curves of the curved wall faces 201 and 201 by the cell lid 30 has been described, but the adjustment method is not limited thereto, and the pressing force may be adjusted by changing the thickness of the electrode group 40 to be inserted. In addition, the pressing force may be adjusted by both of the methods.

In addition, the curved wall face 201 of the cell case 20 for pressing the electrode group 40 which is contained in the inner portion in the stacking direction may be one face. That is, the wall face facing the curved wall face 201 may be a flat face.

The present invention is not limited to the embodiments described above, and is able to be variously changed within the scope of the appended claims. In addition, an embodiment which is obtained by suitably combining technical means disclosed in each different embodiment is included in a technical scope of the present invention.

### INDUSTRIAL APPLICABILITY

The present invention realizes a secondary cell having high cycle characteristics, and thus is able to be widely used in a general secondary cell, and in particular, is able to be preferably used for a large lithium ion secondary cell which is used for power supply for driving a motor or a storage cell for domestic use.

### REFERENCE SIGNS LIST

1 secondary cell
20 cell case
30 cell lid
40 electrode group
41 positive electrode plate
42 negative electrode plate
43 separator
201 curved wall face
411 positive electrode terminal
421 negative electrode terminal

1. A secondary cell in the shape of an approximately rectangular parallelepiped which contains an electrode group of a stacked structure formed of a positive electrode plate including a cathodic active material layer and a negative electrode plate including an anodic active material layer facing each other with a separator interposed therebetween, the secondary cell comprising:
a cell case of which one face of the approximately rectangular parallelepiped is opened, and
a cell lid that seals the opening,
wherein the cell case is formed of a metal material, a pair of two facing faces among four faces each forming one side of the opening of the cell case are curved wall faces in the shape of being curved toward an inner side of the cell case, and
the two facing curved wall faces press the electrode group in a stacking direction of the electrode group, and portions of the curved wall faces with which the electrode group is in contact are subjected to an insulation process.

2. The secondary cell according to claim 1,
wherein a thickness of the curved wall faces is greater than or equal to a thickness of the cell lid.

3. The secondary cell according to claim 1,
wherein the cell lid is fixed, between the two facing curved wall faces, in a state of pressing and widening curves of the curved wall faces.

4. The secondary cell according to claims 3,
wherein a distance between top portions of the curves of the two facing curved wall faces is in a range of 0.8 times to 1 time with respect to a length of a side of the cell case which is parallel to the stacking direction.

5. The secondary cell according to claim 1,
wherein the cell lid is provided with a positive electrode terminal electrically connected to the positive electrode plate of the electrode group, and a negative electrode terminal electrically connected to the negative electrode plate of the electrode group.

6. The secondary cell according to any one of claims 1 to 5,
wherein a surface area of the electrode group which is perpendicular to the stacking direction is 450 cm2 or more, a length of a long side of the surface is 1.5 times or more with respect to a length of a short side thereof, and a cell capacity is 100 Ah or more.
